(19) United States
(12) Patent Application Publication
(10) Pub. No.: US 2020/0034833 A1
(43) Pub. Date: Jan. 30, 2020

(54) SYSTEM FOR DETERMINISTIC PROCESSING OF TEMPORALLY SIGNIFICANT, SEQUENTIALLY SIGNIFICANT AND/OR COST CONSCIOUS DIGITAL LEDGER PUBLICATIONS

(71) Applicant: Go Daddy Operating Company, LLC, Scottsdale, AZ (US)

(72) Inventors: Bennett I. Oscar Collen, Boston, MA (US); Christopher Robert Murdock, New York, NY (US); Matthew Rubino, North Reading, MA (US)

(21) Appl. No.: 16/521,518

(22) Filed: Jul. 24, 2019

Related U.S. Application Data
(60) Provisional application No. 62/702,594, filed on Jul. 24, 2018.

(51) Int. Cl. G06Q 20/38; G06F 16/27; G06F 16/23; G06Q 50/06

(52) U.S. Cl. CPC G06Q 20/389; G06Q 50/06; G06F 16/2379; G06F 16/27

(57) ABSTRACT

Systems and methods are provided for generating a deterministic model for scheduling requests to a distributed ledger network to record transactions in a distributed ledger, and further for optimizing transaction parameters based on prior performance of the distributed ledger network, characteristics of the data being recorded, and user-supplied parameters restricting transaction costs and wait times. Based on the model outputs, the system selects a gas price and a time to submit the request in order to optimize the processing of the request. The system is adaptable to processing groups of documents, such as publications, to be recorded, according to a deterministic selection of the next document, to a sequence of the documents, or to a time limit by which each document must be recorded.

### CROSS-REFERENCE TO RELATED APPLICATIONS

This application is a nonprovisional of U.S. Patent Application No. 62/702,594, filed under the same title on Jul. 24, 2018, and incorporated fully herein by reference.

### FIELD OF THE INVENTION

The present invention generally relates to methods and systems for scheduling requests to record transactions in a distributed ledger, and more specifically relates to optimizing interactions with a blockchain network based on transaction cost and processing delay.

### SUMMARY OF THE INVENTION

The present invention provides systems and methods for one or more computing devices to communicate with one or more distributed ledger systems via a distributed ledger network, and to optimize requests to record a transaction on the one or more distributed ledger systems; the optimization can be designed to balance the cost to process the transactions on the network against an expected delay to process the transaction, in light of a desired cost and a desired transaction recordation timestamp provided by a user.

In certain embodiments, an entity will submit a payload containing a distributed ledger publication to a system interface, along with a digital location identifier(s) representing the location(s) where the system will respond when it deterministically reaches a point at which a response is required. The system will then submit the publication to one or more distributed ledgers specified in the request to the system in order to generate a published state for that payload on the distributed ledger or ledgers and generate a transaction identifier (reference identifier representing the publication on the distributed ledger; e.g. transaction hash, signed transaction, etc.). The system may then monitor the state of that transaction identifier on the distributed ledger until the distributed ledger reports a different state, the system reports a failure, or the system reaches the end of a specified interval or any other non-limiting events that may occur during the process of examining or monitoring a transaction identifier.

In certain embodiments, once a processing event is reached, the system will report back to the entity via the provided digital location identifiers. This provides the entity with the option to produce an appropriate response to a given situation such as, but not limited to, completion, failure or lapse of interval.

In certain embodiments, the system may report a failure or lapse in interval event to which an entity may respond with a new payload intended to overwrite the initial payload. This allows an entity to react to a failure or a time sensitive situation by modifying the original payload in order to achieve an intended outcome that didn't at first occur. The entity also has the option to cancel the publication, if allowed by the digital ledger, or doing nothing to continue in the current state.

In certain embodiments, the system may report a success or publishing event of the distributed ledger payload to which an entity may respond with an entirely new payload, digital location identifiers and related data. Such a situation allows for sequentially dependent payloads to be published in an entirely predictable and deterministic manner.

Thus, in one aspect, the present disclosure provides a system including one or more server computers communicatively coupled to a network and in communication, via the network, with a distributed ledger network comprising a plurality of nodes that maintain a distributed ledger, the one or more server computers each having a processor and memory, the memories collectively storing machine-readable program instructions that, when executed by the corresponding processor of each of the one or more server computers, cause the one or more server computers to: receive a request to record a publication in the distributed ledger, the request including request data describing the publication; provide the request data as input to a deterministic model describing previous usage of the distributed ledger network; receive, as outputs of the deterministic model, transaction parameters including an interval describing a maximum time to wait for a transaction associated with the request to be processed by the distributed ledger network, and a recommended gas price that, based on a time of request, the request data, and the previous usage, is expected to cause the recordation to complete before the interval elapses from an initiation time of the transaction; submit a transaction request to the distributed ledger network, the transaction request including the publication and a gas price determined from the recommended gas price, the transaction request being submitted at the initiation time; receive a transaction identifier associated with the transaction request from the distributed ledger network; using the transaction identifier, monitor a state of the transaction request on the distributed ledger network until the interval expires or the state changes to complete; responsive to a change in the state of the transaction request, generate a notification informing a submitting entity of the request of the change; monitor for user input submitted in response to the notification; and, responsive to receiving the user input, modify the transaction request according to the user input to produce a resubmission request and submit the resubmission request to the distributed ledger network.

The deterministic model may include a plurality of intelligence factors used to analyze: network data describing historical usage of the distributed ledger network; and, feedback data describing previous transactions executed by the one or more servers. The request may be to record a series of sequential publications including the publication, the request data further describing each of the series of sequential publications and a sequence of the publications, and the one or more server computers, responsive to each transaction completing until the series is completely recorded, may repeat the steps for each publication in the series according to the sequence. Each of the series of sequential publications may contain proof of usage of a trademark, and the one or more servers may enable the submitting entity to generate a timeline representation of a usage history of the trademark by sequentially recording the series of sequential publications in the distributed ledger. Each of the series of sequential publications may contain a copyrighted work, and the one or more servers may enable the submitting entity to generate a timeline representation of a history of the copyrighted work by sequentially recording the series of sequential publications in the distributed ledger. Each of the series of sequential publications may contain proof of usage of a domain name by a domain owner, and the one or more servers may enable the submitting entity to generate a timeline representation of a usage history of the domain name by sequentially recording the series of sequential publications in the distributed ledger.

The request may be to record a series of deterministic publications including the publication, the request data further describing each of the series of deterministic publications, the outputs further including an identification of a next publication in the series to submit for recordation. The recommended gas price may be further based on publication data of the identified next publication, and the one or more server computers may, responsive to each transaction completing until the series is completely recorded: resubmit the request data describing each remaining unrecorded publication of the series as updated inputs to the deterministic model; receive from the deterministic model a determination of the next publication to record and an update, based on the next publication, to the transaction parameters; and repeat the steps using the next publication and the updated transaction parameters to record the next publication in the distributed ledger.

The request may be to record a series of deterministic publications including the publication, the request data further describing each of the series of deterministic publications; the outputs may further include, for each of the series of deterministic publications, a corresponding recommended time and a corresponding recommended gas price each determined by the deterministic model based on a historical pattern of average accepted gas prices and a plurality of expected transaction durations each corresponding to one of the series of deterministic publications, and the one or more servers may schedule a corresponding transaction request for each of the series of deterministic publications at the corresponding recommended time and the corresponding recommended gas price of the deterministic publication.

The request data may include a critical time by which the publication must be recorded, the deterministic model determining the interval and the recommended gas price based on the critical time; the one or more servers, repeatedly at consecutive expirations of the interval until the state changes to complete or the critical time is reached, may increase the gas price and resubmit the transaction request. The request data may include a desired transaction cost, the transaction parameters further comprise a recommended time to submit the transaction request, the recommended time based on a historical pattern of average accepted gas prices and an expected transaction duration, and the one or more servers submit the transaction request to the distributed ledger network at the recommended time. The request data may include both a desired transaction cost and a critical time by which the publication must be recorded, the transaction parameters further including a recommended time to submit the transaction request, the recommended time based on a historical pattern of average accepted gas prices and an expected transaction duration and selected so that the transaction is expected to complete by the critical time, and the one or more servers submit the transaction request to the distributed ledger network at the recommended time.

In another aspect, the present disclosure provides a system including: a first data store to maintain monitored transaction hashes; a second data store to maintain interval and cost strategies; one or more servers communicatively coupled to the first and second data stores and to a network and in communication, via the network, with a distributed ledger network comprising a plurality of nodes that maintain a distributed ledger, the one or more server computers each having a processor and memory, the memories collectively storing machine-readable program instructions that, when executed by the corresponding processor of each of the one or more server computers, cause the one or more server computers to check the monitored transaction hashes in the distributed ledger; and, an application programming interface (API) enabling computing devices of one or more entities to interface with the one or more servers via the network. The one or more servers may be further configured to, responsive to checking the monitored transaction hashes, provide feedback to a deterministic model that suggests subsequent interval strategies based on history and context. The one or more servers may be further configured to, responsive to checking the monitored transaction hashes, provide feedback to a deterministic model that suggests subsequent cost strategies based on history and context.

The one or more servers may further: receive a request to record a publication in the distributed ledger, the request including request data describing the publication; determine, based on the request data, a time of the request, and the interval and cost strategies, an interval describing a maximum time to wait for a transaction associated with the request to be processed by the distributed ledger network and a recommended gas price that is expected to cause the recordation to complete before the interval elapses from an initiation time of the transaction; submit a transaction request to the distributed ledger network, the transaction request including the publication and a gas price determined from the recommended gas price, the transaction request being submitted at the initiation time; receive a transaction identifier associated with the transaction request from the distributed ledger network; store the transaction identifier as one of the monitored transaction hashes; monitor for user input associated with the transaction identifier; and, responsive to receiving the user input, modify the transaction request according to the user input to produce a resubmission request and submit the resubmission request to the distributed ledger network.

The interval and cost strategies may be determined from network data describing historical usage of the distributed ledger network. The request may be to record a series of sequential publications including the publication, the request data further describing each of the series of sequential publications and a sequence of the publications, and the one or more server computers, responsive to each transaction completing until the series is completely recorded, may repeat steps for each publication in the series according to the sequence.

The request may be to record a series of deterministic publications including the publication, the request data further describing each of the series of deterministic publications; the interval and cost strategies may be determined from a historical pattern of average accepted gas prices and a plurality of expected transaction durations each corresponding to one of the series of deterministic publications, and the one or more servers may further determine, for each of the series of deterministic publications and based on the interval and cost strategies, a corresponding recommended time and a corresponding recommended gas price, and schedule a corresponding transaction request for each of the series of deterministic publications at the corresponding recommended time and the corresponding recommended gas price of the deterministic publication.

The request data may include a critical time by which the publication must be recorded, and the one or more servers determine the interval and the recommended gas price based on the critical time, and repeatedly, at consecutive expirations of the interval until the state changes to complete or the critical time is reached, increase the gas price and resubmit the transaction request. The request data may include a desired transaction cost, and the one or more servers further determine a recommended time based on a historical pattern of average accepted gas prices and an expected transaction duration, and submit the transaction request to the distributed ledger network at the recommended time.

It should be appreciated that the claimed invention allows a user of a computing device having an interface to a distributed ledger network to optimize scheduling of ledger transaction requests according to user-provided requirements such as transaction cost tolerance, time sensitivity, likelihood of successful recordation, sequencing of transactions, and the like.

The above features and advantages of the present invention will be better understood from the following detailed description taken in conjunction with the accompanying drawings.

### BRIEF DESCRIPTION OF THE DRAWINGS

FIG. 1 is a block diagram of an example computing system for processing deterministic, cost conscious, temporally or sequentially significant publications interfacing with one or more distributed ledgers.

FIG. 2 is a diagram of an example data flow using the system of FIG. 1 for submitting publications to a distributed ledger.

FIG. 3 is a diagram of an example data flow as in FIG. 2, in which the entity is a trademark owner (or administrative manager) and the distributed ledger is the Ethereum network.

FIG. 4 is a diagram of an example data flow as in FIG. 2, in which the entity is a domain registrar and the distributed ledger is the Ethereum network.

### DETAILED DESCRIPTION

The present invention will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A computer network is a collection of links and nodes (e.g., multiple computers and/or other devices connected together) arranged so that information may be passed from one part of the computer network to another over multiple links and through various nodes. Non-limiting examples of computer networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users on clients and websites hosted on servers. Hundreds of millions of people around the world have access to computers connected to the Internet via Internet Service Providers (ISPs). The Internet can also be used to deploy sub-networks dedicated to particular uses. These networks can have their own communication protocols, software applications, access rights, and security measures. In one recently-developed example, a distributed ledger network allows network participants to connect to the network with a computing device a cooperate with the other network participants to maintain a secure distributed ledger by each keeping a copy of the ledger and executing an agreed-upon protocol to validate requests to record information to the ledger. Ledger users can then access the distributed ledger network and submit transaction requests. Public distributed ledger networks can publish the information recorded in the ledger.

In publishing information to distributed ledgers (distributed consensus of replicated, shared, and synchronized digital data; e.g. to a digital ledger database such as blockchain, Hashgraph, Hyperledger, Algorand, etc.) an entity utilizing the distributed ledger will undoubtedly find themselves waiting as the distributed ledger network discovers and reaches consensus on their publication. Distributed ledger networks fluctuate on their ability and willingness to process a particular publication at any given point in time. Many factors can contribute to this fluctuation, including but not limited to the code of the technology itself, parameters set by nodes participating in the network (for example, minimum fee they will accept), the number of pending publications awaiting processing by the network and parameters dictated by the publication itself about how it should be processed (for example maximum fee the entity is willing to pay). Generally, the most popular and technologically stable distributed networks have the highest fees for processing transaction requests on the network. An entity publishing to a network is concerned about how long it will take for their publication to be processed and how much it will cost them; there is a balance to be struck between fees and time to publication that an entity must work out in some fashion to achieve their goals.

Interacting with a distributed ledger network requires an entry point to that network. Participating entities can maintain their own network nodes in order to gain access, or utilize publicly available solutions such as Infura, Blockcyphe, etc. Existing public solutions offer ease of use for submitting publications to a network so that an entity need not maintain their own node. Unfortunately, publications can take minutes, hours or even days to process depending on the fluctuating factors mentioned above. Even when a user submits publications with constant parameters such as maximum specified fee, the network can react with wildly different processing times even from hour to hour. Depending on the technology of the distributed ledger used, submitted publications are discovered and published in sequential order. This means that having hundreds of pending publications (e.g. transactions, smart contracts, data writes, etc.) can lead to a tremendous amount of waiting and manual managing, thus making operating at scale cumbersome. This is especially true when the publications submitted are temporally and sequentially significant, because one publication must be discovered and published to the ledger before a subsequent publication can even be submitted. This has significant implications for clearance of trades and crypto “buys” as exchanges and purchasers try to mitigate “front running” a block (i.e. seeing transaction data for a pending block related to some crypto trade, and buy or sell a cryptocurrency based on the trade that's about to happen, and push their transaction through first with a higher gas price).

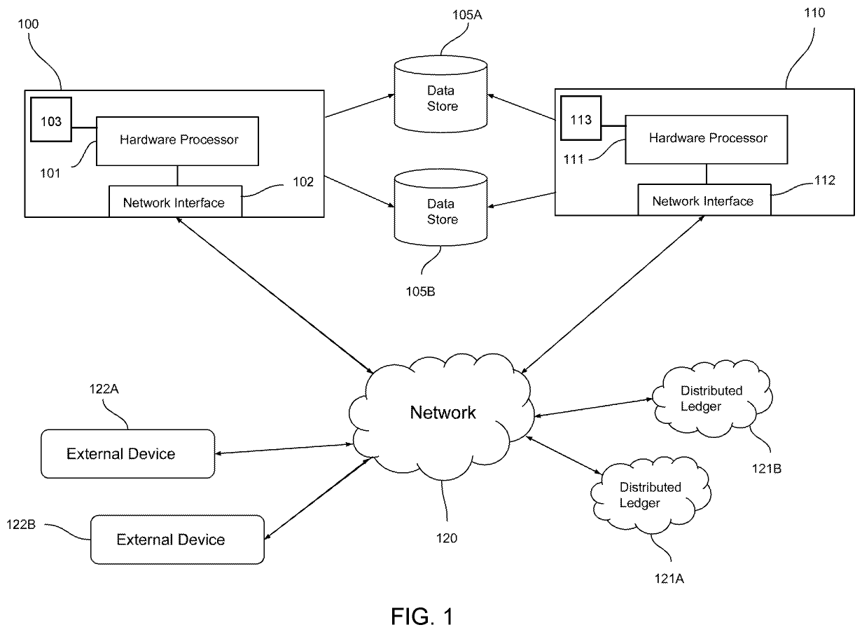

FIG. 1 shows a block diagram of a system that, in accordance with an example embodiment of the invention, is comprised of a processing system interface 100 and a processing system 110 that communicatively connect to one or more distributed ledgers 121A, 121B and one or more external computing devices 122A, 122B via a computer network 120 such as the Internet.

The processing system interface 100 may be any suitable computing device, computer system, set of interconnected computing devices, application programming interface(s), or combination thereof, that includes a hardware processor 101 (e.g. one or more CPUs) coupled to electronic data storage 103 (e.g. volatile or non-volatile memory). The processing system 110 also may be any suitable computing device, computer system, set of interconnected computing devices, application programming interface(s) (API(s)), or combination thereof, that includes a hardware processor 111 (e.g. one or more CPUs) coupled to electronic data storage 113 (e.g. volatile or non-volatile memory). In certain example embodiments, both processing system interface 100 and processing system 110 may reside on the same hardware. One or both of the processing system interface 100 and the processing system 110 communicate with one or more data stores 105A, 105B which exist on external dedicated storage hardware, to store data (in the form of data structures or other logical structures; e.g. local storage, relational database systems, key value stores, etc.) relevant to monitoring the state of transaction identifiers issued to one or more distributed ledgers 121A,B. In certain example embodiments, data stores 105A,B may be coupled within the same hardware unit as either the processing system interface 100 or the processing system 100 rather than exist on externally dedicated storage hardware.

The processing system interface 100 receives electronic data messages (payload) from external devices (entities such as external computing devices 122A,B), via network interface 102, which may include a distributed ledger publication, and may include an indicator of which distributed ledger (or ledgers) the publication is for. The received publication is submitted to the specified distributed ledger (or ledgers) 121A,B to generate a reference (or references) to the pending publication on that distributed ledger (or ledgers). The payload may also contain an interval strategy (time based interval and number of attempts before failure) and digital location identifiers (e.g. URIs identifying endpoints where electronic data messages can be sent) which will be used to communicate to the originating party, changes of publication state (such as a completion event) or other events such as interval lapse or publication failure. The payload may also contain any other data that may be pertinent to monitoring the state of the publication.

One or more of the data stores 105A,B store the relevant parts of the payloads received by processing system interface 100 including the transaction identifier received from submission to the distributed ledger. In certain example embodiments, data stores 105A,B may store digital wallets (the representation of an entity on the digital ledger and notion of ownership; e.g. cryptocurrency wallet, digital wallet, etc.) that will be used in the process of submitting publications to digital ledgers 121A,B on behalf of the submitting entity.

The processing system 110 accesses data stores 105A,B for information related to any publications to a distributed ledger by the processing system interface 100. Stored transaction identifiers enable it to search, monitor or retrieve general information about corresponding publications by interfacing with distributed ledgers 121A,B. Using transaction identifiers, the processing system 110 may attempt to locate the state of a publication on the distributed ledger. Once a change of state has been identified, a lapse of the interval strategy occurs, or a failure of any kind, the processing system may react by informing the entity of the situation. The processing system may provide data including the state of the publication, publication data and or metadata retrieved from the digital ledger and or any other information that may be useful to the entity in determining how to react to event.

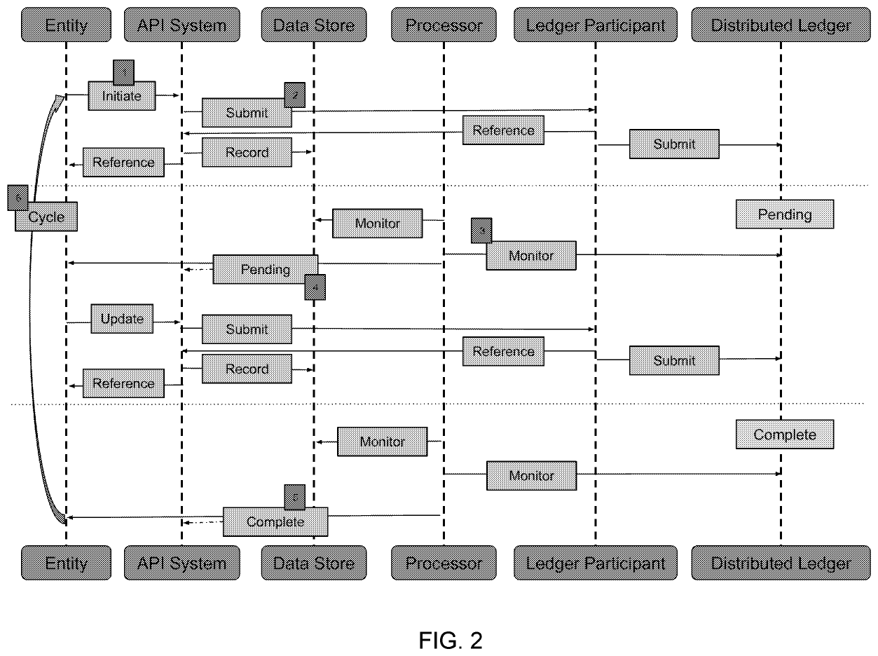

FIG. 2 shows an example flow of data element transmission and processing by components of the system of FIG. 1 in order to schedule and execute a request to record a transaction on a distributed ledger, and produce a result of the request. In some embodiments, the transaction constitutes publishing a document or a plurality of documents, such as a series of temporally and sequentially significant publications, to a distributed ledger optionally with the ability to intelligently optimize against various factors, and to optimize for parallel submission in a similarly intelligent optimization. System users, which can be human or automated and examples of which include publishing entities, trademark owners, domain name registrants, and the like, as well as distributed ledger network node operators, are represented in FIG. 2 by the computing device the user uses to access the distributed ledger network (e.g., external devices 122A,B of FIG. 1). In one embodiment, at the numbered states of the data flow the following occurs:

1. An entity initiates a transfer of data to a distributed ledger. For example, a user enters commands into an interface on the external device, causing the external device to execute an API call to an API system to start the process. A user interface is optionally presented to the entity for initiating, managing or observing any particular part of the process.
2. The API system submits the data to the distributed ledger and in turn receives a transaction identifier (marked “reference”) for the transaction of recording the publication on the ledger. The API system records the transaction identifier in a data store, so the state of the transaction (e.g. pending, complete, etc.) may be observed. Information which may include the transaction identifier may be returned to the entity. In some embodiments, the API system may accept a digital wallet to create the publication on behalf of the entity.
3. A processor (e.g., the processing system 110 of FIG. 1) monitors the data store for newly recorded transaction identifiers and correlates them with the records in the distributed ledger on a periodic basis.
4. Optionally, over time and based on intelligence, the processor and API system, in accordance with the entity, can modify the data of the pending transaction request as necessary to facilitate processing of the transaction until such a time as the transaction is complete. Potentially the transaction identifier is updated. Modification could include changing the gas price, changing the data to be recorded (e.g., publication data), canceling the transaction request, as well as other actions.
5. The processor monitors the distributed ledger to determine when the transaction is complete; the processor notifies the API system and the entity of this event allowing for the capture of data about the recorded transaction. For example, the entity can receive an address within the distributed ledger where the publication is recorded, and/or a timestamp of when the transaction was completed.
6. Optionally, this also allows the entity via the API system to submit a subsequent publication of data for recordation, and the processes begins again and may cycle until such time that all publications in a particular sequence are recorded.

In some embodiments, the system may use a deterministic model describing patterns in usage of the distributed ledger network, in order to set elements (e.g., time to submit the request, gas price to offer, expected time to complete) of a transaction request to record a publication. The model may include intelligence factors related to one or more target distributed ledger and their associated network(s); non-limiting examples of such intelligence factors can be based on previous history, the current and past working state of the distributed ledger, time to completion, size of data published, cost of completion, as well as others. Data about a completed, pending, or terminated transaction to record a publication may be captured and used in the system's deterministic model to improve the model's intelligence factors. Non-limiting examples of such data may include start costs, finish costs, distributed ledger currency values, result of request, time of start, time of completion, frequency of spend increases, amount of spend increases, size of data published, as well as others. In some embodiments, the model may comprise one or more data aggregation and analysis modules, such as machine learning or other artificial intelligence platforms that use algorithms based on the intelligence factors; the deterministic model may be trained on existing data such as the data described above, and may gradually improve its predictions of transaction duration, acceptable gas prices, etc., based on new usage data and feedback describing completed and/or failed previous transactions. Non-limiting example machine learning platforms include neural networks, simple linear regression, and the like.

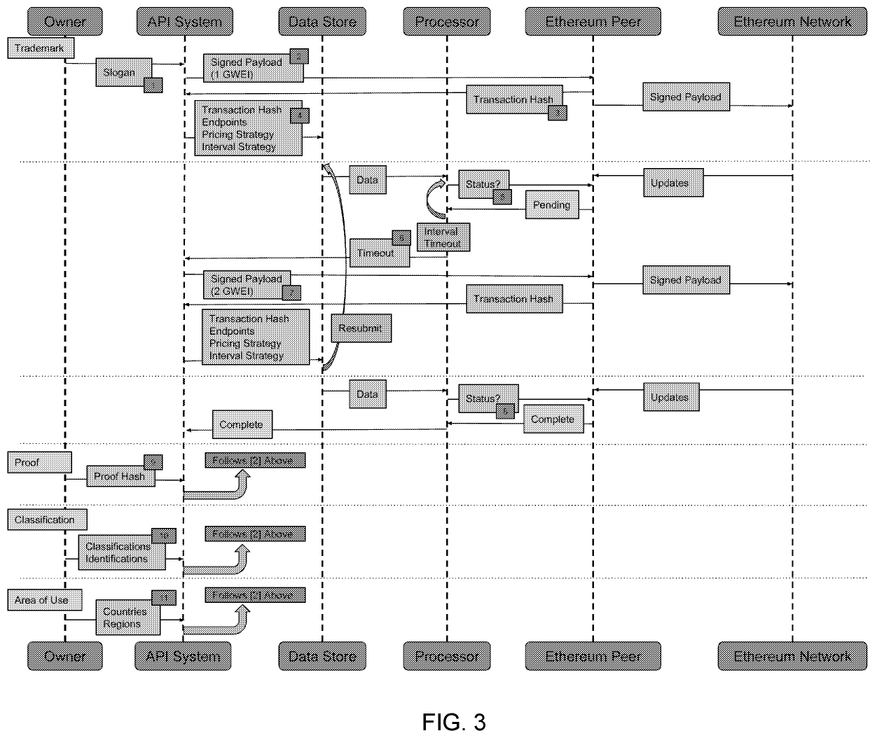

FIG. 3 illustrates a variation on the data flow of FIG. 2 in which a trademark owner is using the system to build a verified, immutable recorded timeline of evidence that pertains to their trademark use, ownership, and rights, and to publish the timeline for public record. In order to have this timeline series, the owner must first publish information about the trademark (start of the timeline) and then publish subsequent entries linked back to it. This can be accomplished with a smart contract library also published to a distributed ledger network that supports smart contracts, such as the Ethereum network. The trademark owner can submit their trademark and be notified when recordation is complete, thus allowing them to start their timeline and then follow up with the submission of their proof of use, areas of use and classifications, and any other pertinent information about their trademark use, rights, or ownership.

In some embodiments, the trademark owner may have previously engaged the processing system (e.g., processing system 110 of FIG. 1, via processing system interface 100 of FIG. 1) and entered data describing their desired pricing and interval strategies as well as digital wallet information. With such data recorded, the owner may enable the API system to sign the payload for the owner as well as automatically increment the transaction as needed. In one embodiment, at the numbered states of the data flow the following occurs:

1. The trademark owner submits their trademark information (represented by a slogan in this example) to the API system.
2. The API system uses a digital wallet to sign the transaction thus generating the payload. This payload is priced at a starting gas price (e.g., in GWEI, the transaction fee unit on the Ethereum network). The signed payload is then submitted to the Ethereum network via a peer (i.e., a computing device operating as a node on the Ethereum network).
3. The peer is able to generate the transaction hash for the given payload and returns that to the API system for tracking purposes.
4. Based in part on any user-provided data indicating requirements and preferences for the recordation, the API system decides on pricing strategies, interval strategies, and communication endpoints. For example, the API system provides the basic transaction details and the user-provided data to the deterministic model as inputs, and receives output data which it stores in the data store along with the transaction hash.
5. A processor monitoring the data store notices the new entry with the transaction hash. It takes the hash and uses it to lookup the transaction in the Ethereum network. Typically, in the case of Ethereum, this is either complete or still pending. The processor will continue to monitor the transaction hash based on the specification of the interval strategy (for example check every 15 minutes for 6 hours).
6. At the end of the interval, the transaction is still pending. The processor will communicate with the API system and inform it of that case.
7. The API system generates another signed payload, this time raising the gas price willing to be paid from 1 GWEI to 2 GWEI (100% increase). This increases the likelihood of the transaction being included in the next block of the Ethereum blockchain and thus completing. The payload is submitted to the Ethereum network again, replacing the existing transaction. A new transaction hash is obtained and this information is put back into the data store for continued monitoring. The process cycles accordingly and could repeat several times before the transaction is completed.
8. Eventually, when the processor checks the state of the transaction it will find it to be complete. This allows it to contact the API system, this time with a state of complete.
9. With the trademark recorded in the ledger, the owner can begin creating the timeline by submitting proof of use, rights, ownership, etc. The API system can then create a new signed payload as representation of information about the trademark (i.e. proof of use, rights, or ownership). This proof would be appended to the timeline started with the first submission. The process would loop starting at step two [2] submitting a new transaction and waiting for it to complete.
10. The trademark owner can also provide or update trademark classification information. Upon receipt the API system submits the classification data for the trademark following from step [2] again creating a new transaction and waiting for it to complete.
11. The trademark owner can also provide or update trademark areas of use information. Upon receipt the API system would know to submit the areas of use of the trademark. The duration of time between a completion notification and the new transaction generated in steps nine [9], ten [10] and eleven [11] could be a matter of seconds or it could be a matter of weeks or months; it depends on what information the owner has already provided to the API system and at what points in time they do so.

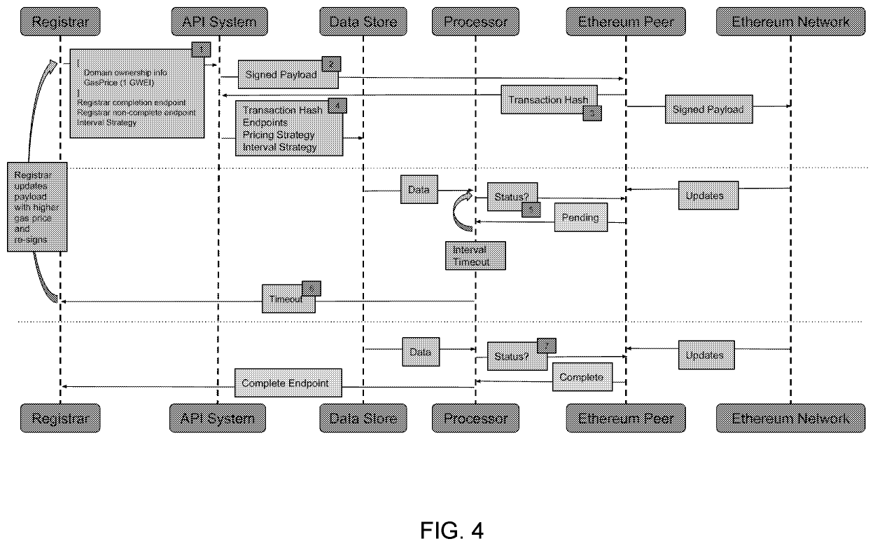

FIG. 4 shows an example variation on the data flow of FIG. 2, in which a domain name registrar is capturing ownership events in a timeline for a particular domain for public record. In this situation the registrar would have chosen to sign their own payload and manage network fees on their own. In the event of a non-completed transaction, the registrar would decide all actions, whether that be canceling the transaction, increasing fees, letting this continue as is or any other desired action. Thus they would need to inform the API system of the interval strategy as well as the endpoint hooks to be interacted with given either a complete or non-complete scenario. In one embodiment, at the numbered states of the data flow the following occurs:

1. The registrar submits a request to the API system. In this example embodiment, the registrar is not integrated with the system and must provide a pre-signed digital ledger payload (containing the domain ownership information they are documenting, the gas price for the publication and any other metadata required by Ethereum), the endpoint for the system to notify when the publication completes, the endpoint for the system to notify in the case of some other event, such as an interval timeout, and the interval strategy.
2. The signed payload portion of the request is then forwarded on to an Ethereum peer. In this embodiment, the processing system (i.e., processing system 110 of FIG. 1) may include at least one computing device that operates its own Ethereum peer.
3. The Ethereum peer generates and returns a transaction identifier and then submits the payload to the Ethereum network.
4. At this point the API system has all information required to prompt the start of the publication monitoring loop. It stores this information in the data store.
5. The processor, which is monitoring the data store, notices the new transaction information available and uses that data to check the state of the transaction on the Ethereum network. This happens repeatedly in accordance with the interval strategy specified by the registrar (for example every 5 minutes for 2 hours) while the state of the transaction remains pending.
6. When the interval strategy times out (the max number of specified retries is reached) the system notifies the registrar's non-complete endpoint that a timeout has occurred, providing any known information about the state of the transaction at that time. The registrar may then submit a new transaction overwriting the existing but with a higher gas price in order to increase the likelihood that the transaction completes. This cycle back to [1] may repeat several times before the transaction completes.
7. Eventually, the transaction will complete and the system will notify the registrar via the completion endpoint that the registrar provided. The registrar can then take any necessary post completion actions desired.

In an ideal world, publications to a distributed ledger would be cost effective and take little or no time to complete. Code libraries designed for interaction with digital ledgers are designed with the assumption that a publication will complete quickly enough for the code library itself to handle the state change from pending to complete. The reality however, is that an entity that has submitted a publication to a digital ledger either with the aid of a code library or with a more manual approach will often be waiting quite a while for that publication to complete. Code libraries are not designed to wait for hours or even days for a response that they can handle and will likely timeout or error long before the publication changes state. Many factors contribute to this waiting period including those that are less predictable such as overall network load (referring to the digital ledger network). This unpredictability becomes a problem for those entities requiring a level of consistency for their publications.

Existing systems that interface with distributed ledgers are generally at the “distributed ledger participant” layer which doesn't address this problem. At this layer, a system is able to submit publications to the distributed ledger but will have no information about the state of those publications or be able to react to various state changes (or lack thereof) without manually interacting with the distributed ledger. The system introduces a new layer just above the distributed ledger participant layer, encapsulating and interfacing with the distributed ledger participant(s), automatically tracking the publications submitted via the system to the distributed ledger participant(s).

With this tracking mechanism introduced by the system, entities submitting publications to a digital ledger via the system benefit from the following improvements and advantages.

In the system, publications are deterministic, meaning the system will always have an outcome regarding a publication submitted to it and will update the entity of that outcome. These points in time for notification can be defined by the submitting entity. Standard blockchain interaction mechanisms do not have this quality and may only return a response from the network initially with an identifier that will allow an entity to manually check upon their publication. While this is the primary improvement over existing blockchain interaction systems, the following advantages can be derived from this improvement.

The system handles sequentially bound publications. Some publications, whether they are related to executable code on the digital ledger or simply related to transfers of base currency, require other publications to execute either before or after their own execution. Due to the system's deterministic monitoring of publications, it allows for automated, strict adherence to a required ordering of publications. Existing infrastructure requires an entity to check the status of their publications manually in order to determine if they can then submit another publication that is dependent on the initial publication completing.

The system allows an entity interfacing with it to be cost conscious. In the system, a submitting entity is able to receive state changes about its publications as well as notification if state has NOT changed after a specified time interval. These notifications, which do not exist for standard blockchain interaction, allow the entity to provide an automated reaction to such a case. One potential reaction would be to update the existing publication with a publication specifying a higher publication fee. This allows an entity to start with a lower than average publication fee which can then be raised if the publication is taking too long to complete.

The system is also time conscious. If an entity would like their publication completed as quickly as possible, they can set a short time interval so that they are receiving notifications quickly regarding the state of their publication and raise the publication fee rapidly until the publication is completed. In the event that the critical time period has lapsed the entity could also opt to cancel the publication, saving themselves the need to continue publishing something they no longer need.

Ultimately the system provides a way to provide automated reactions as needed to state changes (or lack thereof) of a publication to a digital ledger. The submitting entity is given control, with defaults and intelligent recommendations, of the price, duration and other such strategies.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

We claim:

1. A system comprising one or more server computers communicatively coupled to a network and in communication, via the network, with a distributed ledger network comprising a plurality of nodes that maintain a distributed ledger, the one or more server computers each having a processor and memory, the memories collectively storing machine-readable program instructions that, when executed by the corresponding processor of each of the one or more server computers, cause the one or more server computers to:
a. receive a request to record a publication in the distributed ledger, the request including request data describing the publication;
b. provide the request data as input to a deterministic model describing previous usage of the distributed ledger network;
c. receive, as outputs of the deterministic model, transaction parameters comprising:
an interval describing a maximum time to wait for a transaction associated with the request to be processed by the distributed ledger network; and
a recommended gas price that, based on a time of request, the request data, and the previous usage, is expected to cause the recordation to complete before the interval elapses from an initiation time of the transaction;
d. submit a transaction request to the distributed ledger network, the transaction request including the publication and a gas price determined from the recommended gas price, the transaction request being submitted at the initiation time;
e. receive a transaction identifier associated with the transaction request from the distributed ledger network;
f. using the transaction identifier, monitor a state of the transaction request on the distributed ledger network until the interval expires or the state changes to complete;
g. responsive to a change in the state of the transaction request, generate a notification informing a submitting entity of the request of the change;
h. monitor for user input submitted in response to the notification; and
i. responsive to receiving the user input:
modify the transaction request according to the user input to produce a resubmission request; and
submit the resubmission request to the distributed ledger network.

2. The system of claim 1, wherein the deterministic model comprises a plurality of intelligence factors used to analyze: network data describing historical usage of the distributed ledger network; and, feedback data describing previous transactions executed by the one or more servers.

3. The system of claim 1, wherein the request is further to record a series of sequential publications including the publication, the request data further describes each of the series of sequential publications and a sequence of the publications, and the one or more server computers, responsive to each transaction completing until the series is completely recorded, repeats steps b)-i) for each publication in the series according to the sequence.

4. The system of claim 3, wherein each of the series of sequential publications contains proof of usage of a trademark, and the one or more servers enable the submitting entity to generate a timeline representation of a usage history of the trademark by sequentially recording the series of sequential publications in the distributed ledger.

5. The system of claim 3, wherein each of the series of sequential publications contains a copyrighted work, and the one or more servers enable the submitting entity to generate a timeline representation of a history of the copyrighted work by sequentially recording the series of sequential publications in the distributed ledger.

6. The system of claim 3, wherein each of the series of sequential publications contains proof of usage of a domain name by a domain owner, and the one or more servers enable the submitting entity to generate a timeline representation of a usage history of the domain name by sequentially recording the series of sequential publications in the distributed ledger.

7. The system of claim 1, wherein the request is further to record a series of deterministic publications including the publication, the request data further describes each of the series of deterministic publications, the outputs further include an identification of a next publication in the series to submit for recordation, the recommended gas price is further based on publication data of the identified next publication, and the one or more server computers, responsive to each transaction completing until the series is completely recorded:
resubmit the request data describing each remaining unrecorded publication of the series as updated inputs to the deterministic model;
receive from the deterministic model a determination of the next publication to record and an update, based on the next publication, to the transaction parameters; and
repeat steps d)-i) using the next publication and the updated transaction parameters to record the next publication in the distributed ledger.

8. The system of claim 1, wherein:
the request is further to record a series of deterministic publications including the publication, the request data further describing each of the series of deterministic publications;
the outputs further include, for each of the series of deterministic publications, a corresponding recommended time and a corresponding recommended gas price each determined by the deterministic model based on a historical pattern of average accepted gas prices and a plurality of expected transaction durations each corresponding to one of the series of deterministic publications; and
the one or more servers schedule a corresponding transaction request for each of the series of deterministic publications at the corresponding recommended time and the corresponding recommended gas price of the deterministic publication.

9. The system of claim 1, wherein the request data further comprises a critical time by which the publication must be recorded, the deterministic model determines the interval and the recommended gas price based on the critical time, and the one or more servers, repeatedly at consecutive expirations of the interval until the state changes to complete or the critical time is reached, increases the gas price and resubmits the transaction request.

10. The system of claim 1, wherein the request data further comprises a desired transaction cost, the transaction parameters further comprise a recommended time to submit the transaction request, the recommended time based on a historical pattern of average accepted gas prices and an expected transaction duration, and the one or more servers submit the transaction request to the distributed ledger network at the recommended time.

11. The system of claim 1, wherein the request data further comprises a desired transaction cost and a critical time by which the publication must be recorded, the transaction parameters further comprise a recommended time to submit the transaction request, the recommended time based on a historical pattern of average accepted gas prices and an expected transaction duration and selected so that the transaction is expected to complete by the critical time, and the one or more servers submit the transaction request to the distributed ledger network at the recommended time.

12. A system comprising:
a. a first data store to maintain monitored transaction hashes;
b. a second data store to maintain interval and cost strategies;
c. one or more servers communicatively coupled to the first and second data stores and to a network and in communication, via the network, with a distributed ledger network comprising a plurality of nodes that maintain a distributed ledger, the one or more server computers each having a processor and memory, the memories collectively storing machine-readable program instructions that, when executed by the corresponding processor of each of the one or more server computers, cause the one or more server computers to check the monitored transaction hashes in the distributed ledger; and
d. an application programming interface (API) enabling computing devices of one or more entities to interface with the one or more servers via the network.

13. The system of claim 12, wherein the one or more servers are further configured to, responsive to checking the monitored transaction hashes, provide feedback to a deterministic model that suggests subsequent interval strategies based on history and context.

14. The system of claim 12, wherein the one or more servers are further configured to, responsive to checking the monitored transaction hashes, provide feedback to a deterministic model that suggests subsequent cost strategies based on history and context.

15. The system of claim 12, wherein the one or more servers further:
a. receive a request to record a publication in the distributed ledger, the request including request data describing the publication;
b. determine, based on the request data, a time of the request, and the interval and cost strategies:
an interval describing a maximum time to wait for a transaction associated with the request to be processed by the distributed ledger network; and
a recommended gas price that is expected to cause the recordation to complete before the interval elapses from an initiation time of the transaction;
c. submit a transaction request to the distributed ledger network, the transaction request including the publication and a gas price determined from the recommended gas price, the transaction request being submitted at the initiation time;
d. receive a transaction identifier associated with the transaction request from the distributed ledger network;
e. store the transaction identifier as one of the monitored transaction hashes;
f. monitor for user input associated with the transaction identifier; and
g. responsive to receiving the user input:
modify the transaction request according to the user input to produce a resubmission request; and
submit the resubmission request to the distributed ledger network.

16. The system of claim 15, wherein the interval and cost strategies are determined from network data describing historical usage of the distributed ledger network.

17. The system of claim 15, wherein the request is further to record a series of sequential publications including the publication, the request data further describes each of the series of sequential publications and a sequence of the publications, and the one or more server computers, responsive to each transaction completing until the series is completely recorded, repeats steps b)-g) for each publication in the series according to the sequence.

18. The system of claim 15, wherein:
the request is further to record a series of deterministic publications including the publication, the request data further describing each of the series of deterministic publications;
the interval and cost strategies are determined from a historical pattern of average accepted gas prices and a plurality of expected transaction durations each corresponding to one of the series of deterministic publications; and
the one or more servers further:
determine, for each of the series of deterministic publications and based on the interval and cost strategies, a corresponding recommended time and a corresponding recommended gas price; and
schedule a corresponding transaction request for each of the series of deterministic publications at the corresponding recommended time and the corresponding recommended gas price of the deterministic publication.

19. The system of claim 15, wherein the request data further comprises a critical time by which the publication must be recorded, and the one or more servers determine the interval and the recommended gas price based on the critical time, and repeatedly, at consecutive expirations of the interval until the state changes to complete or the critical time is reached, increase the gas price and resubmit the transaction request.

20. The system of claim 15, wherein the request data further comprises a desired transaction cost, and the one or more servers further determine a recommended time based on a historical pattern of average accepted gas prices and an expected transaction duration, and submit the transaction request to the distributed ledger network at the recommended time.
